(19) United States
(12) Patent Application Publication
(10) Pub. No.: US 2026/0292019 A1
(43) Pub. Date: Sep. 24, 2026

(54) SYSTEM AND METHOD FOR CREATING AND SELECTING NETWORK REPOSITORY FUNCTION INSTANCES

(71) Applicant: Verizon Patent and Licensing Inc., Basking Ridge, NJ (US)

(72) Inventors: Emerando M. Delos Reyes, Pleasant Hill, CA (US); Nitul Mehta, Nashua, NH (US); Tony Ferreira, Greenwich, CT (US); Michael Kondratiuk, Hillsborough, NJ (US)

(21) Appl. No.: 19/086,755

(22) Filed: Mar. 21, 2025

(51) Int. Cl. H04L 67/1034; H04L 41/0668; H04L 41/0816; H04L 41/50; H04W 4/50

(52) U.S. Cl. CPC H04L 67/1034; H04L 41/0668; H04L 41/0816; H04L 41/5058; H04W 4/50

(57) ABSTRACT

A system may include a processor. The processor may be configured to: determine whether an operating capacity of a first instance of network function (NF) has reached a limit; when the operating capacity of the first instance of the NF is determined to have reached the limit: create a second instance of the NF within a core network and configure the core network to have a consumer NF instance, which is integrated into the core network after the second instance of the NF is created, send a service request for the NF directly to the first instance.

### BACKGROUND INFORMATION

Fifth Generation (5G) networks introduce several advancements that enhance flexibility, efficiency, and scalability compared to previous generations. A key innovation is the adoption of a Service-Based Architecture (SBA), which enables network functions to communicate through standardized Application Programming Interfaces (APIs). This architecture simplifies network management, improves interoperability, and accelerates the deployment of new services. Additionally, SBA facilitates seamless integration with Multi-Access Edge Computing (MEC) clusters, optimizing traffic steering and reducing latency. At the core of SBA is the Network Repository Function (NRF), which acts as a centralized registry for network functions (NFs), enabling efficient discovery, registration, and communication among the NFs. By leveraging the SBA and NRF, 5G networks achieve greater resource efficiency, faster service rollout, enhanced security, and improved network performance.

### BRIEF DESCRIPTION OF THE DRAWINGS

FIG. 1 illustrates concepts described herein.

FIG. 2 illustrates an exemplary network environment in which systems and methods described herein may be implemented.

FIG. 3 depicts exemplary Fifth Generation (5G) core network components, according to an implementation.

FIG. 4 is a flow diagram of an example process that is associated with creating and selecting Network Repository Functions (NRFs).

FIGS. 5A and 5B are diagrams illustrating example messages that are exchanged between 5G core components during a process that is associated with creating and selecting NRFs.

FIG. 6 depicts exemplary functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may include a cellular network. A cellular network may be uniquely identified by a Public Land Mobile Network (PLMN) Identifier (ID).

The systems and methods described herein pertain to the creation and selection of Network Repository Functions (NRFs) within a provider network. The NRF is a component of the Service-Based Architecture (SBA) in Fifth Generation (5G) networks, as defined by Third Generation Partnership Project (3GPP) standards. The NRF serves as a centralized registry for other Network Functions (NFs) within an operator's network, enabling the NFs to register, discover, and communicate with each other through standardized Application Programming Interfaces (APIs).

Scalability is a factor for the NRF in a 5G Core deployment, particularly as the number of connected devices and data demands continue to grow. To ensure seamless performance, the NRF enables the dynamic instantiation, scaling, and termination of network functions as needed, optimizing network efficiency.

Horizontal scaling may play a role in enhancing network resilience. By distributing the workload across multiple NRF instances, the service provider may reduce the impact of failures or outages. For example, if one NRF instance goes down/fails, the remaining instances absorb the additional load, ensuring continuous and reliable network service. However, horizontally scaling the NRF presents several challenges.

One major issue in horizontal scaling is ensuring consistent load distribution across multiple NRF instances. Uneven distribution can lead to performance bottlenecks and overload specific nodes, negatively impacting overall network efficiency. Additionally, when a new NF is introduced into the provider network, careful analysis is required to ensure that its interactions with the NRF do not disrupt the balance of workload distribution.

One potential approach considered is deploying a load balancer between the NFs and the NRF instances. While this deployment could help distribute traffic across NRFs, traditional load balancers lack connection “stickiness”, meaning they do not maintain persistent associations between NFs and NRFs. This can result in unpredictable routing behavior, making maintenance and troubleshooting more complex.

To support scalability, predictability, and ease of management, a more dynamic and structured approach is required. The systems and methods described herein provide a solution for NRF capacity expansion, while also simplifying operational and management tasks.

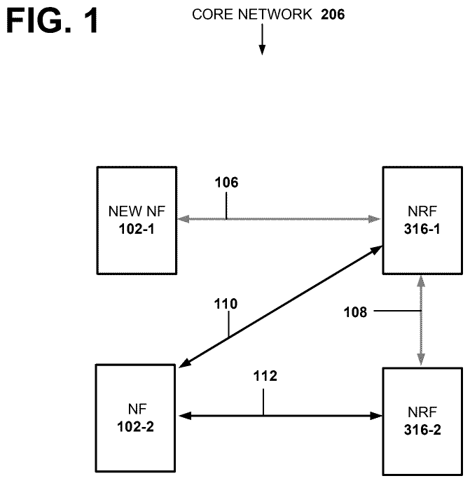

FIG. 1 illustrates concepts described herein. As shown, core network 206 (to be described below) within the provider network includes: one or more NFs, such as a new NF 102-1 and NF 102-2; an anchor NRF 316-1, and a minion or secondary NRF 316-2. The system creates or instantiates a minion NRF 316-2 when anchor NRF 316-1 or the system determines that NRF 316-1 has reached its operational capacity (either in terms of memory or processing capacity). NRF 316-2 is synchronized to NRF 316-1 to the extent necessary to handle network function calls that NRF 316-1 will no longer handle. New NF 102-1 is new in the sense that it has been just introduced/incorporated into core network 206 to begin its operation.

When new NF 102-1 locates NRF 316-1 via, for example, a Domain Name System (DNS) server or another mechanism, NRF 316-1 may exchange a series of messages to register NF 102-1 with anchor NRF 316-1 (FIG. 1; messages 106). Assuming that NRF 316-1 has reached its maximum capacity, in one implementation, NRF 316-1 may query minion NRF 316-2 (108), querying whether NRF 316-2 can handle the registration request specific to new NF 102-1. When NRF 316-1 receives a reply from NRF 316-2 (108), NRF 316-1 may forward the reply (106), which includes the network address of NRF 316-2, to NF 102-1. Subsequently, NF 102-1 may then register with NRF 316-2 (the messages not shown in FIG. 1).

In a different implementation, when NRF 316-1 receives the registration request from new NF 102-1, NRF 316-1 may request NRF 316-2 to register NF 102-1 at NRF 316-2. If NF 102-1 is successfully registered at NRF 316-2, NRF 316-2 may send a reply to NRF 316-1, indicating the registration was successful. NRF 316-1 may then forward the reply, which includes the address of NRF 316-2, to NF 102-1.

In either case, once new NF 102-1 is registered at NRF 316-2, when another NF 102-2 queries NRF 316-1 for information about NF 102-1 (110) (e.g., send a discovery request to NRF 316-1), NRF 316-1 may determine whether it has the requested information. When NRF 316-1 determines that it does not have the requested information, NRF 316-1 may forward a reply (110) that includes the address of NRF 316-2. Upon receipt of the address of NRF 316-2, NF 102-2 may send the query to NRF 316-2 (112). In response, NRF 316-2 may provide the requested information to NF 102-2 (112).

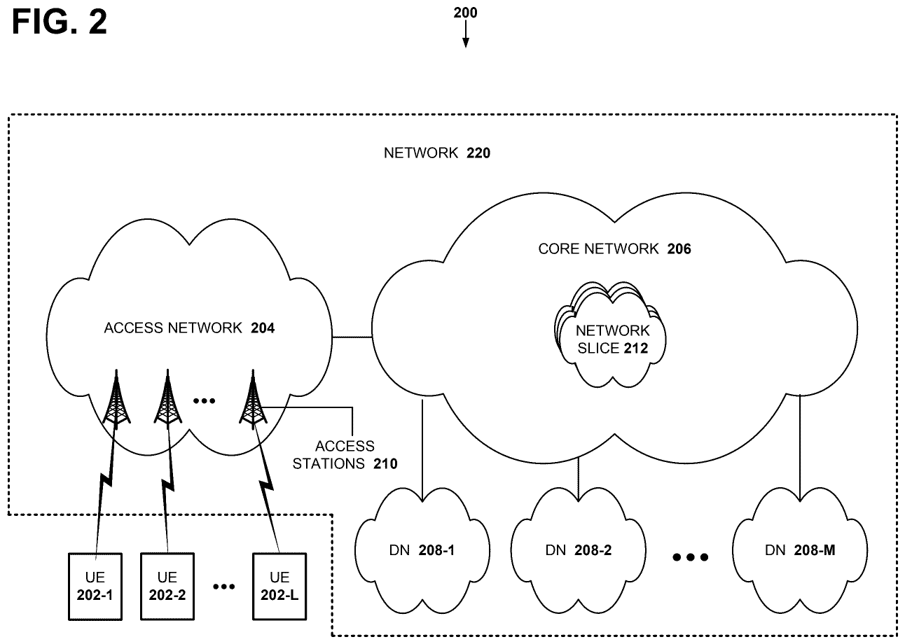

FIG. 2 illustrates an exemplary network environment 200 in which the systems and methods described herein may be implemented. As shown, network environment 200 may include User Equipment devices (UEs) 202-1 through 202-L (collectively referred to as UEs 202 and generically referred to as UE 202), access network 204, core network 206, and data networks (DNs) 208-1 through 208-M (collectively referred to as data networks (DNs) 208 and generically as data network (DN) 208). Access network 204, core network 206, and data networks 208 may be part of a provider network 220.

UEs 202 may include devices capable of Fourth Generation (4G) (e.g., Long-Term Evolution (LTE)) communication, 5G New Radio (NR) communication, and/or other wireless communication. Examples of UE 202 include: a smart phone; a tablet device; a smart watch; a global positioning system (GPS) device; a laptop computer; a media playing device; a portable gaming system; a desktop computer; Internet-of-Things (IoT) devices, such as sensors (e.g., temperature, humidity, water levels, chemical compounds, etc.); smart meters (e.g., water, gas, electricity, etc.); wearables (e.g., fitness trackers); asset trackers (e.g., vehicles, goods, etc.); Narrow Band (NB)-IoT devices; Long-Term Evolution (LTE) Cat-M1 devices; smart home devices (e.g., security cameras); industrial IoT devices (e.g., monitoring devices); medical devices (e.g., patient monitoring devices); agricultural devices (e.g., livestock trackers); and fleet management devices (e.g., vehicle telematics). Additional examples of UEs 202 include: a Fixed Wireless Access (FWA) device; a Customer Premises Equipment (CPE) device with 4G and 5G capabilities. In some implementations, UE 202 may include a wireless Machine-Type-Communication (MTC) device that communicates with other devices over a machine-to-machine (M2M) interface, such as LTE-M or CAT-M1 devices and NB-IoT devices.

UEs 202 may be associated with a user that is subscribed to network 220 to receive various services. UE 202 may operate in accordance with a service profile or a subscription profile stored at network 220. To receive network services, UEs 202 attach to network 220 wirelessly and establish communication sessions with network 220.

Access network 204 may facilitate UE 202's connection to core network 206 by establishing and managing over-the-air channels with UE 202 and backhaul channels with core network 206. These channels enable the relay of information between UE 202 and core network 206. Access network 204 comprises LTE, 5G NR, or other advanced radio access networks, featuring components such as central units (CUs), distributed units (DUs), radio units (RUs), and/or base stations. These network components are illustrated in FIG. 2 as access stations 210 (herein generically referred to as access station 210) for establishing and maintaining over-the-air channel with UEs 202. In some implementations, access station 210 may include a 4G, 5G, or another type of base station (e.g., evolved Node B (eNB), next generation Node B (gNB), etc.) that comprises one or more radio frequency (RF) transceivers. In some implementations, access station 210 may be part of an evolved Universal Mobile Telecommunications Service (UMTS) Terrestrial Radio Access Network (eUTRAN).

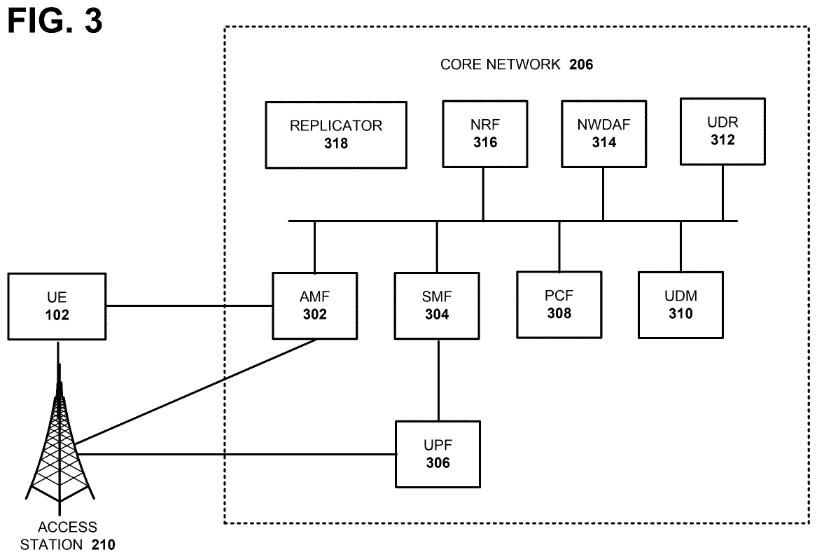

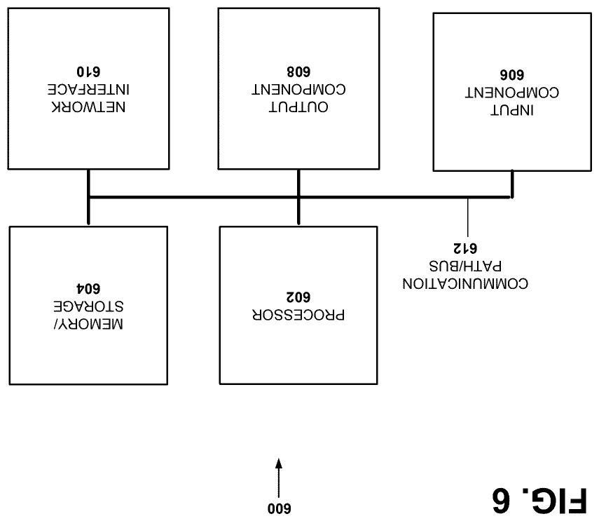

Core network 206 may oversee communication sessions for subscribers connecting via access network 204. For instance, core network 206 may facilitate the establishment of Internet Protocol (IP) connections between UEs 202 and data networks 208. The components within core network 206 can be either dedicated hardware elements or virtualized functions operating atop a shared physical infrastructure using Software Defined Networking (SDN). An SDN controller, for example, may leverage an adapter to implement one or more core network components through virtualized entities like virtual network functions (VNF) virtual machines, Cloud Native Function (CNF) containers, event-driven serverless architecture interfaces, or other SDN components. This shared physical infrastructure may include devices 600, as described below with reference to FIG. 6, within a cloud computing center associated with core network 206. Moreover, core network 206 may encompass 5G core network components, 4G core network components, or other types of core components. Further elaboration on some of these components is provided below with reference to FIG. 3.

As further shown, core network 206 may include one or more network slices 212. Depending on the embodiment, network slices 212 may be implemented within other networks, such as access network 204 and/or data network 208. Access network 204, core network 206, and data networks 208 may include multiple instances of network slices 212 (generically or individually referred to as network slice 212). Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport network components, Central Processing Unit (CPU) cycles, memory, etc. Furthermore, each network slice 212 may be configured to meet a different set of requirements and may be associated with a particular Quality of Service (QoS) Class Identifier (QCI), a type of service, a 5G QoS Identifier (5QI), and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example.

Each network slice 212 may be associated with an identifier, herein referred to as a Single Network Slice Selection Assistance Information (S-NSSAI) and/or a network slice instance ID. Each UE 202 that is configured to access a particular network slice 212 may be associated with corresponding data, stored in core network 206 for example, which includes the S-NSSAI that identifies the network slice 212.

Data networks 208 may include one or more networks connected to core network 206. In some implementations, a particular data network 208 may be associated with a data network name (DNN) in 5G and/or an Access Point Name (APN) in 4G. UE 202 may request a connection to data network 208 using a DNN or APN. In a 5G network, data network 208 that is implemented on network slice 212 may nonetheless be associated with a DNN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an AS (also referred to as application). An application may render services to other applications running on UEs 202 and may establish communication sessions with UEs 202 via core network 206.

For clarity, FIG. 2 does not show all components that may be included in network environment 200 (e.g., routers, bridges, wireless access points, additional networks, additional access stations 210, data centers, portals, etc.). Depending on the implementation, network environment 200 may include additional, fewer, different, or a different arrangement of components than those illustrated in FIG. 2.

FIG. 3 depicts exemplary 5G core network components 302-316 in core network 206 according to an implementation. One or more of core network components (e.g., components 302-316), in conjunction with other network components (e.g., component 318), may implement systems and methods for creating and selecting NRF instances. As shown, core network 206 may include NFs, such as an Access and Mobility Management Function (AMF) 302, a Session Management Function (SMF) 304, a User Plane Function (UPF) 306, a Policy Control Function (PCF) 308, a Unified Data Management (UDM) 310, a Unified Data Repository (UDR) 312, a Network Data Analytics Function (NWDAF) 314, and an NRF 316. In this exemplary implementation, core network 206 may also include a replicator 318.

Although FIG. 3 shows core network 206 as including 5G core network components 302-316 and replicator 318, in practice, core network 206 may include additional, fewer, and/or different core network components than those illustrated in FIG. 3. For example, core network 206 may include 4G core network components (e.g., a Mobility Management Entity (MME), a Serving Gateway (SGW), a Packet Data Network Gateway (PGW), a Policy and Charging Rules Function (PCRF), a Home Subscriber Server (HSS), a Service Capability Exposure Function (SCEF), an and AS). In another example, core network 206 may include an Authentication Server Function (AUSF), a Charging Function (CHF), a Network Slice Selection Function (NSSF), a Network Exposure Function (NEF), etc. In still yet another example, core network 206 may not include replicator 318.

AMF 302 may perform registration management, connection management, reachability management, mobility management, lawful intercepts, Short Message Service (SMS) transport between UE 202 and a Short Message Service Function (SMSF), session management messages transport between UE 202 and SMF 304, access authentication and authorization, location services management, functionality to support non-3GPP access networks, and/or other types of management processes.

SMF 304 may perform session establishment, session modification, and/or session release, perform IP address allocation and management, perform Dynamic Host Configuration Protocol (DHCP) functions, perform selection and control of UPF 306, configure traffic steering at UPF 306 to guide the traffic to the correct destinations, terminate interfaces toward PCF 308, perform lawful intercepts, charge data collection, support charging interfaces, control and coordinate charging data collection, terminate session management parts of Non-Access Stratum (NAS) messaging, perform downlink data notification, manage roaming functionality, and/or perform other types of control plane processes for managing user plane data.

UPF 306 may maintain an anchor point for intra/inter-Radio Access Technology (RAT) mobility, maintain an external protocol data unit (PDU) point of interconnect to a particular data network (e.g., data network 208), perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN node (e.g., access station 210), and/or perform other types of user plane processes.

PCF 308 may support policies to control network behavior, provide policy rules to control plane functions (e.g., to AMF 302, SMF 304, etc.), access subscription information relevant to policy decisions, make policy decisions, and/or perform other types of processes associated with policy enforcement. When PCF 308 receives an SM Policy Association Create message from SMF 304, PCF 308 may provide a response that includes a session rules and one or more Policy and Control Charging (PCC) rules.

UDM 310 may maintain subscription information for UEs 202, manage subscriptions, generate authentication credentials, handle user identification, perform access authorization based on subscription data, perform network function registration management, maintain service and/or session continuity by maintaining assignment of SMF 304 for ongoing sessions, support SMS delivery, support lawful intercept functionality, and/or perform other processes associated with managing user data. UDM 310 may store data that it manages in a UDR 312. UDR 312 may include subscription data associated with the subscribers of network services (e.g., users of UE 202), policy data, and application data. The policy data may include policy rules and parameters associated with the policy rules. The application data may comprise information and/or data collected by applications.

NWDAF 314 may collect analytics information associated with access network 206. For example, NWDAF 314 may obtain telemetry information relating to components 302-312 and 316 and provide collected telemetry information relating to other core components, such as replicator 318. In some implementations, NWDAF 314 may generate Key Performance Indicator (KPI) data relating to network functions 302-312 and 316 (e.g., bandwidth utilization, storage utilization, memory utilization, etc.) and provide the information to other core network functions.

NRF 316 may support a service discovery function and maintain profiles of available network function instances and their supported services. An NF profile may include an NF ID, an NF type, a PLMN ID associated with the NF, network slice IDs associated with the NF, capacity information for the NF, service authorization information for the NF, supported services associated with the NF, endpoint information for each supported service associated with the NF, and/or other types of NF information.

Replicator 318 may include logic to determine the operating capacity of the NFs that replicator 318 has been assigned to monitor and/or replicate when the NF capacity reaches its limit. In some implementations, rather than monitoring the operating capacities of the NFs, replicator 318 may receive the monitored operating capacity information from the NFs or from NWDAF 314. For example, replicator 318 may receive, from NRF 316, messages that indicate its storage usage, memory usage, processor usage, bandwidth usage, and/or database usage (e.g., the number of NF profiles that NRF 316 has in its database).

When replicator 318 determines that the operating capacity of a particular NF has reached its limit, replicator 318 may create a new instance of the particular NF (“minion NF”). Next, replicator 318 may cause the particular NF to pause its services while synchronization between the newly created NF to the particular NF takes place. Once the NFs are synchronized, replicator 318 may restart the particular NF.

Depending on the implementation, each of the core network components 302-316 may or may not be configured to monitor its own operating capacity and compare the operating parameters against predefined thresholds. For example, an NF may assess whether its memory usage, storage usage, bandwidth utilization, or processor load exceeds a threshold, measured in absolute values (e.g., bytes, instructions per second) or percentages. If an NF (e.g., one of NFs 302-316, such as NRF 316) detects that its capacity limit has been reached, that NF may send a notification—including its current capacity and/or threshold values—to replicator 318.

In other implementations, NFs 302-316 may not monitor their own capacity or send notifications regarding the monitored capacity. Instead, replicator 318 may determine NF capacities independently or obtain this information from, for example, NWDAF 314. When a new NF (e.g., a new NRF) is instantiated and needs to be synchronized with an existing NF, the existing NF may pause its operations to prevent inconsistencies during synchronization. For instance, if a new NRF is being synchronized to NRF 316, NRF 316 may temporarily suspend operation while NF profiles are being synchronized. An NF may initiate or resume its operation automatically or upon receiving a command from replicator 318, signaling the start or completion of synchronization.

Once replication and synchronization are complete, the original NF (referred to as the anchor NF) may continue operating as a producer NF. When the anchor NF receives a service request from a consumer NF, the anchor NF must decide whether to process the request itself or delegate the request to a minion NF. This decision is based on factors such as current capacity levels and whether the requested data or service is available locally.

For example, when anchor NRF 316 receives a query related to UPF 306, anchor NRF 316 first determines whether it can handle the request. If anchor NRF 316 decides not to handle the request—due to capacity limitations or missing information—anchor NRF 316 may query the minion NRF to check whether the minion NRF can process the request. If the minion NRF responds affirmatively, the anchor NRF delegates the request accordingly.

If the anchor NF decides to process the request itself, the anchor NF provides the required service directly to the consumer NF. Otherwise, if delegation is necessary, the anchor NF forwards the network address of the minion NF to the consumer NF, allowing the consumer NF to communicate directly.

Upon receiving confirmation that a minion NF can handle its request, the consumer NF resubmits the request directly to the minion NF. In some implementations, a consumer NF may store the network address of the minion NF for similar future requests. For example, if anchor NRF 316 informs a consumer NF that a minion NRF will handle queries related to UPF 306, the consumer NF may create an association between UPF 306 queries and the minion NRF. Moving forward, the consumer NF will send all such requests directly to the minion NRF, bypassing NRF 316.

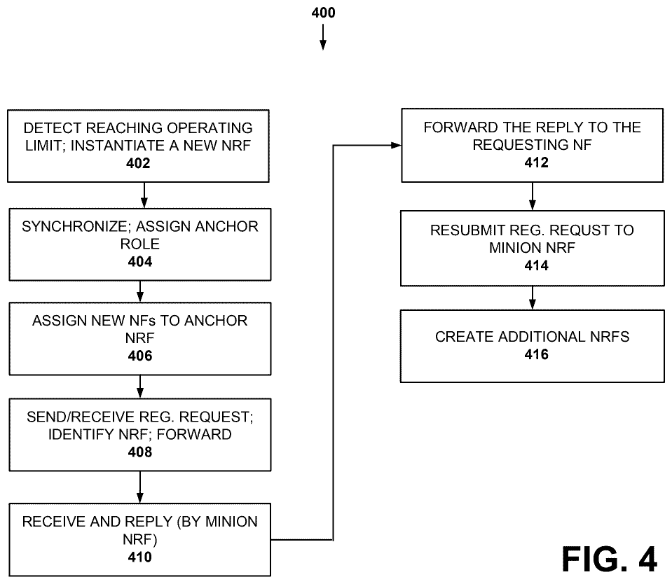

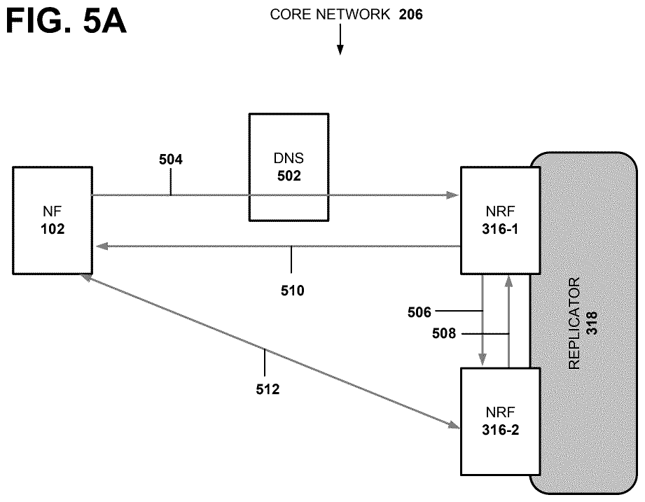

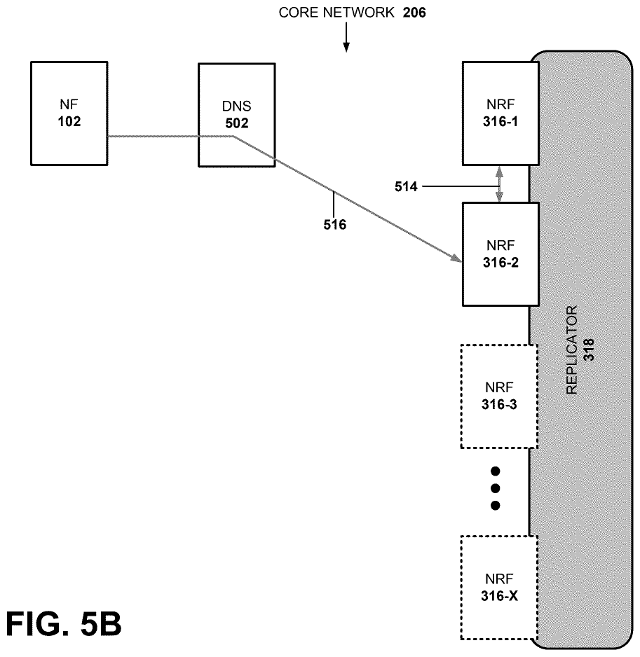

FIG. 4 is a flow diagram of an example process 400 that may be performed in accordance with an exemplary implementation for creating and selecting NRF instances. FIGS. 5A and 5B illustrate example messages that may be exchanged by the components of the system during process 400. Each block in FIG. 4 and FIGS. 5A and 5B is not intended to signify every action performed by the components; and each arrow in FIGS. 5A and 5B is not intended to indicate every message sent or received by the components. Process 400 may be performed one or more core components 302-318.

As shown in FIG. 4, process 400 may include detecting that an NF has reached its operating limit (block 402). For example, NRF 316 or replicator 318 may use monitored NRF data to determine whether NRF 316 has reached its maximum capacity (e.g., whether its storage utilization reached a threshold limit; whether its profile database has reached its limit; whether its processor utilization has reached its limit; etc.). Upon detecting that the limit has been reached, replicator 318 may create a new instance of NRF 316, such as a minion NRF 316 (block 402). For example, as shown in FIG. 5A, replicator 318 may create NRF 316-2.

Process 400 may further include synchronizing the new NRF instance to the existing NRF (block 404). For example, in FIG. 5A, upon being integrated into core network 206, NRF 316-2 may initiate a synchronization process with NRF 316-1. The information exchanged between NRF 316-1 and 316-2 may include the identities of the NFs already associated with each NRF 316-1 and 316-2, in addition to the load and capacity status of both NRF 316-1 and NRF 316-2. The synchronization process may ensure that both NRF 316-1 and NRF 316-2 maintain up-to-date data (e.g., NF profiles) and, thus, are in a consistent state.

Process 400 may further include assigning the role of anchor to the original NRF 316 (block 404). For example, NRF 316-1 may expand its functionality by adopting the role of anchor NRF. The enhanced role may enable the anchor NRF to oversee the allocation and management of connectivity requests originating from a new NF that is yet to be assigned a specific NRF.

Process 400 may further include assigning new NFs to the anchor NRF (block 406). For example, when a new NF 102 is introduced to core network 206, a network operator and/or system associated with managing core network 206 may assign the new NF to anchor NRF 316-1. By assigning the new NF to anchor NRF 316-1, this may simplify assignment processes. That is, the system may not require the network operator or the system to determine to which NRF the new NF should be assigned. For example, the new NF may be automatically assigned to the anchor NRF. The process may not only simplify the deployment but also ensure consistency and efficiency during network expansion.

Process 400 may further include sending, by the new NF, a registration request to anchor NRF 316 (block 408); receiving the registration request by anchor NRF 316 (block 408); and forwarding, by anchor NRF 316-1, the request to a minion NRF 316 (block 408). For example, as shown in FIG. 5A, when NF 102 is introduced into core network 206, NF 102 may send a registration request to NRF 316-1 (anchor NRF 316-1, to which NF 102 is assigned) (arrow 504). In some implementations, NF 102 may determine the network address of NRF 316-1 via a DNS server 502 and send the registration request to the network address returned by DNS server 502. When anchor NRF 316-1 receives the registration request and determines that it has reached its operational/capacity limit, NRF 316-1 may evaluate the load and available resources of minion NRFs, using data from NWDAF 314, replicator 318 and/or data from the replication and synchronization processes. After the assessment, anchor NRF 316-1 may forward the registration request to minion NRF 316-2 (arrow 506), which has been identified as having sufficient capacity to handle the demand from NF 102.

Process 400 may further include receiving, by the minion NRF, the forwarded registration request (block 410). For example, NRF 31-2 may receive the registration request forwarded by anchor NRF 316-1. Furthermore, upon receipt of the forwarded registration request, NRF 316-2 (which has the capacity to handle such requests) may acknowledge the receipt by sending a response (e.g., ‘200 OK’ response) to anchor NRF 316-1, indicating that NRF 316-2 is ready to process the registration (arrow 508).

Process 400 may further include forwarding, by the anchor NRF, the reply from the minion NRF to the requesting NF (block 412). For example, when anchor NRF 316-1 receives the reply from minion NRF 316-2, anchor NRF 316-1 may forward the reply to NF 102 (arrow 510). The forwarded reply may include the network address and/or the DNS name of NRF 316-2.

Process 400 may further include the NF resubmitting the registration request to the minion NRF (block 414). For example, upon receiving the forwarded reply from anchor NRF 316-1, NF 102 may resubmit the registration request to minion NRF 316-2. In this subsequent attempt, NF 102 may directly address the request to minion NRF 316-2 (arrow 512). Following a successful connection, the association between NF 102 and the NRF 316-2 is set as permanent.

Process 400 may further include creating additional minion NRFs (block 416). FIG. 5B shows further scaling of core network 206, by repeating the actions of blocks 402-414, with integration of additional NRF 316-3 . . . and NRF 316-X. Whenever a new NF is incorporated into core network 206, anchor NRF 316-1 may execute the previously detailed actions to identify the appropriate minion NRF to fulfill the request from the new NF.

In some implementations, to increase redundancy, anchor NRF 316 may be capable of designating a secondary anchor NRF. As shown in FIG. 5B, anchor NRF 316-1 may select a secondary NRF 316-2 from among NRFs 316 already deployed in core network 206 and communicate the designation to secondary NRF 316-2 (arrow 514). This measure guarantees the availability of anchor NRF services, even in the event that primary anchor NRF 316-1 becomes unavailable (e.g., fails). When primary NRF 316-1 is no longer available, DNS server 502 can be reconfigured so that the DNS name associated with primary NRF 316-1 is associated with the network address of secondary NRF 316-2. Thereafter, when NF 102 queries DNS server 502, DNS server 502 provides the network address of secondary anchor NRF 316-2, and NF 102 can access secondary NRF 316-2 (arrow 516).

FIG. 6 depicts exemplary components of a network device 600. Network device 600 may correspond to or be included in any of the devices and/or components illustrated in FIGS. 1-3 and 5A and 5B (e.g., network 220, UE 202, access network 204, core network 206, data network 208, access station 210, and core network components 302-318). In some implementations, network devices 600 may be part of a hardware network layer on top of which other network layers and NFs may be implemented.

As shown, network device 600 may include a processor 602, memory/storage 604, input component 606, output component 608, network interface 610, and communication path 612. In different implementations, network device 600 may include additional, fewer, different, or different arrangement of components than the ones illustrated in FIG. 6. For example, network device 600 may include line cards, switch fabrics, modems, etc.

Processor 602 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 600 and/or executing programs/instructions.

Memory/storage 604 may include static memory, such as read only memory (ROM), and/or dynamic memory, such as random access memory (RAM), or onboard cache, for storing data and machine-readable instructions (e.g., programs, scripts, etc.). Memory/storage 604 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 604 may be external to and/or removable from network device 600. Memory/storage 604 may include, for example, a Universal Serial Bus (USB) memory stick, a dongle, a hard disk, off-line storage, a Blu-Ray® disk (BD), etc. Memory/storage 604 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 606 and output component 608 may provide input and output from/to a user to/from network device 600. Input/output components 606 and 608 may include a display screen, a keyboard, a mouse, a speaker, a microphone, a camera, a DVD reader, USB lines, and/or other types of components for obtaining, from physical events or phenomena, to and/or from signals that pertain to network device 600.

Network interface 610 may include a transceiver (e.g., a transmitter and a receiver) for network device 610 to communicate with other devices and/or systems. For example, via network interface 610, network device 600 may communicate over a network, such as the Internet, an intranet, cellular, a terrestrial wireless network (e.g., a wireless local area network (WLAN), WIFI, WIMAX, etc.), a satellite-based network, optical network, etc. Network interface 610 may include a modem, an Ethernet interface to a LAN, and/or an interface/connection for connecting network device 600 to other devices (e.g., a Bluetooth interface).

Communication path or bus 612 may provide an interface through which components of network device 600 can communicate with one another.

Network device 600 may perform the operations described herein in response to processor 602 executing software instructions stored in a non-transient computer-readable medium, such as memory/storage 604. The software instructions may be read into memory/storage 604 from another computer-readable medium or from another device via network interface 610. The software instructions stored in memory/storage 604, when executed by processor 602, may cause processor 602 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 4, 5A, and 5B, the order of the actions, messages, and signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A system comprising:
a processor configured to:
determine whether an operating capacity of a first instance of a network function (NF) has reached a limit;
when the operating capacity of the first instance of the NF is determined to have reached the limit:
create a second instance of the NF within a core network; and
configure the core network to have a consumer NF instance, which is integrated into the core network after the second instance of the NF is created, send a service request for the NF to the first instance.

2. The system of claim 1, wherein the processor is further configured to:
synchronize a database of the first instance to a database of the second instance.

3. The system of claim 2, wherein the NF includes a Network Repository Function (NRF), and the database of the first instance includes a database of network profiles, and the service request includes an NRF registration request.

4. The system of claim 3, wherein when the processor determines whether the operating capacity of the first instance of the NF has reached the limit, the processor is configured to:
determine whether the database of the network profiles has reached the limit.

5. The system of claim 1, wherein when configuring the core network, the processor is configured to:
configure a Domain Name System (DNS) server in the core network to provide a network address of the first instance to the consumer NF; or
configure the consumer NF to directly send the service request to the first instance.

6. The system of claim 1, further comprising the first instance of the NF, wherein the first instance is configured to:
receive a registration request from the consumer NF;
forward the registration request to the second instance;
receive a reply from the second instance; and
forward the reply to the consumer NF.

7. The system of claim 6, wherein the consumer NF is configured to:
receive the forwarded reply from the first instance; and
resubmit the registration request to the second instance.

8. The system of claim 1, further comprising another consumer NF, configured to:
send a discovery request to the first instance;
receive a reply from the first instance, indicating that the second instance is to provide an answer to the discovery request; and
resubmit the discovery request to the second instance.

9. The system of claim 1, wherein the processor is further configured to:
configure the second instance to assume a role of the first instance when the first instance fails or stops operating.

10. The system of claim 1, wherein the processor is further configured to:
determine whether an operating capacity of the second instance of the NF has reached another limit; and
when the operating capacity of the second instance of the NF is determined to have reached the other limit, create a third instance of the NF within the core network.

11. A method comprising:
determining whether an operating capacity of a first instance of a network function (NF) has reached a limit;
wherein, when the operating capacity of the first instance of the NF is determined to have reached the limit:
creating a second instance of the NF within a core network; and
configuring the core network to have a consumer NF instance, which is integrated into the core network after the second instance of the NF is created, send a service request for the NF to the first instance.

12. The method of claim 11, further comprising:
synchronizing a database of the first instance to a database of the second instance.

13. The method of claim 12, wherein the NF includes a Network Repository Function (NRF), and the database of the first instance includes a database of network profiles, and the service request includes an NRF registration request.

14. The method of claim 13, wherein determining whether the operating capacity of the first instance of the NF has reached the limit comprises:
determining whether the database of the network profiles has reached the limit.

15. The method of claim 11, wherein configuring the core network comprises at least one of:
configuring a Domain Name System (DNS) server in the core network to provide a network address of the first instance to the consumer NF; or
configuring the consumer NF to directly send the service request to the first instance.

16. The method of claim 11, further comprising:
receiving a registration request from the consumer NF;
forwarding the registration request to the second instance;
receiving a reply from the second instance; and
forwarding the reply to the consumer NF.

17. The method of claim 16, further comprising:
receiving the forwarded reply from the first instance; and
resubmitting the registration request to the second instance.

18. The method of claim 11, further comprising:
sending a discovery request to the first instance;
receiving a reply from the first instance, indicating that the second instance is to provide an answer to the discovery request; and
resubmitting the discovery request to the second instance.

19. The method of claim 11, further comprising:
configuring the second instance to assume the role of the first instance when the first instance fails or stops operating.

20. A non-transitory computer-readable medium comprising processor-executable instructions, which when executed by a processor, cause the processor to:
determine whether an operating capacity of a first instance of a network function (NF) has reached a limit;
when the operating capacity of the first instance of the NF is determined to have reached the limit:
create a second instance of the NF within a core network; and
configure the core network to have a consumer NF instance, which is integrated into the core network after the second instance of the NF is created, send a service request for the NF to the first instance.
